(19) United States
(12) Patent Application Publication
(10) Pub. No.: US 2002/0163717 A1
(43) Pub. Date: Nov. 7, 2002

(54) Confocal imaging apparatus and method using linear line-scanning

(76) Inventor: Jawoong Lee, Inchon (KR)

Correspondence Address: Anderson, Kill & Olick, P.C., 1251 Avenue of the Americas, New York, NY, 10020, US

(21) Appl. No.: 10/138,219

(22) Filed: May 1, 2002

(30) Foreign Application Priority Data
May 4, 2001 (KR) 2001-24362

(51) Int. Cl. G02B 26/08

(52) U.S. Cl. 359/388; 359/202; 359/368; 359/385

(57) ABSTRACT

The present invention relates to a confocal imaging apparatus and a method by which the frame rate and the field of view can be considerably enhanced. The apparatus of the present invention acquires the confocal images of a macroscopic specimen by combining the function of slit confocal optics, one-dimensional optical image processing, linear line-scanning, and compensating the change of the optical path length in real time. According to the present invention, the light is focused to a slit-beam on the specimen and only the light that is scattered back from the focal plane is received in parallel to form the confocal image of the specimen by the slit confocal optics that includes cylindrical lenses, a slit mask, and a line detector. In order to get the image frames, a linear line-scanning means is adopted, which linearly scans the slit-beam focused on the specimen across arbitrary desired planes that are parallel to the slit-direction of the slit-beam. Also, a real-time compensating means of the change in optical path length is adopted to remove the degrading effects on the image that is caused by the change of the optical path length during the scanning of the slit-beam.

### BACKGROUND OF THE INVENTION

1. Field of the Invention

The present invention relates to a confocal imaging apparatus and a method when used to image macroscopic specimens that are larger than those viewed through a microscope.

2. Description of the Related Art

The typically known confocal imaging apparatus is a confocal scanning microscope that has been widely used in cell biology and material science. The confocal scanning microscope acquires the image of a specimen by scanning the focus light-spot across the specimen, and detecting the light scattered from the specimen through a confocal pinhole.

FIG. 1a is a schematic diagram of a known confocal scanning microscope. As depicted in FIG. 1a, the confocal scanning microscope 10 in the prior art includes a light source 12, a beam spatial filter/expander 14, a beam splitter 16, a scanning unit 18, a spherical objective lens 20, a spherical receiving lens 22, a pinhole mask 23, and a detector/image processing unit 26.

The light emitted from the light source 12 is expanded and collimated while passing through the beam spatial filter/expander 14. This collimated beam propagates to the scanning unit 18 via the beam splitter 16. Successively passing through the scanning unit 18 and the objective lens 20, the beam is focused to a spot on the specimen 8 and scanned across the specimen. The light is scattered back from the specimen 8, collected by the objective lens 20, delivered to the receiving lens 22 via beam splitter 16, and focused onto the pinhole mask 23 by the receiving lens 22. At this time, only the light scattered from the focus spot on specimen 8 can propagate to the detector/image processing unit 26 through pinhole 24 formed in pinhole mask 23, but the light scattered from the other parts cannot pass through the pinhole 24. In other words, the out-of-focus blur is essentially absent from confocal images. So, the confocal scanning microscope has excellent three-dimensional spatial resolution. Especially, the confocal scanning microscope is useful to obtain the in-vivo image of the specimen where light is severely scattered.

However, in the case of the confocal scanning microscope that uses a confocal pinhole, it takes a long time to get the image since a raster-scanning of the focus spot across the specimen is required. Besides, the field of view of the confocal scanning microscope is about 1 mm×1 mm at most.

As another example of known technology, there is slit-scanning microscope that was suggested to improve light efficiency and scanning speed. This apparatus gets an image frame by slit-scanning. Slit-scanning uses one-dimensional rotary oscillation of a galvano mirror to scan the slit-beam along the cylindrical surface centered on the rotation axis of the mirror. However, the prior art slit-scanning method cannot be simply adapted to a macroscope due to the considerable error caused by the curvature of scanning trajectory of the slit-beam.

In addition, there is the confocal macroscope, which can scan areas as large as 7.5 cm×7.5 cm, introduced by the Scanning Laser Microscopy Laboratory at the University of Waterloo in Ontario, Canada (please refer to the web site www.confocal.com). The three-dimensional diagram of the suggested confocal macroscope is well depicted in FIG. 1b. This confocal macroscope also takes a long time to get an image since it, like the typical confocal scanning microscope, is based on the raster-scan of a focus spot.

### SUMMARY OF THE INVENTION

It is, therefore, an object of the present invention to provide a confocal imaging apparatus and a method, which can enhance the frame rate and enlarge the field of view compared with the known confocal image forming apparatus, by combining the function of slit confocal optics, one-dimensional optical image processing, linear line-scanning, and compensating the change of optical path length in real time.

To achieve the above object, the present invention provides a confocal imaging apparatus for acquiring confocal images of a macroscopic specimen, which includes: an illuminating means for providing an illuminating beam; a first focusing means for focusing the illuminating beam to a first slit-beam on the specimen; a light-collecting means for collecting the light scattered from the specimen; a second focusing means for focusing the light collected by the light-collecting means to a second slit-beam; a scanning means for scanning the first slit-beam across the arbitrary desired planes that are parallel to the slit-direction of the first slit-beam; an optical path-connecting means for connecting the optical path between the specimen and the apparatus during the scanning of the first slit-beam; a real-time optical path-correcting means for compensating the change of optical path length in real time during the scanning of the first slit-beam; a filtering means for filtering only the second slit beam; and an optical image processing means for forming images of the specimen by extracting the necessary information from the filtered second slit-beam.

Another aspect of the present invention provides a method for acquiring the confocal images of the specimen, which includes the steps of: providing the illuminating beam; focusing the illuminating beam to the first slit-beam on the specimen; collecting the light scattered from the specimen; focusing the collected light to the second-slit beam; scanning the first slit-beam across arbitrary desired planes that are parallel to the slit-direction of the first slit-beam; connecting the optical path between the specimen and the apparatus during the scanning of the first slit-beam; compensating the change of optical path length in real time during the scanning of the first slit-beam; filtering only the second slit-beam and passing the filtered second slit-beam to the optical image processing means; and forming images of the specimen by extracting the necessary information from the filtered second slit-beam.

### BRIEF DESCRIPTION OF THE DRAWINGS

The above objects, features and advantages of the present invention will become more apparent from the following detailed description when taken in conjunction with the accompanying drawings, in which:

FIG. 1a is a schematic diagram of a known confocal scanning microscope;

FIG. 1b is a three-dimensional diagram of a known confocal scanning macroscope;

FIG. 2a is a schematic diagram of a confocal imaging apparatus in accordance with a preferred embodiment of the present invention;

FIG. 2b is a three-dimensional diagram of the confocal imaging apparatus of FIG. 2a;

FIG. 3 is a schematic diagram depicting an example of a slit mask shown in FIG. 2a and FIG. 2b;

FIG. 4 is a block diagram depicting an example of an optical image processing unit shown in FIG. 2a;

FIG. 5 is a block diagram depicting apparatus which can be connected to an image constructing/analyzing unit shown in FIG. 2a;

FIG. 6 is a schematic diagram of a scanning unit 200 shown in FIG. 2a and FIG. 2b;

FIG. 7 is a schematic diagram of a stepped linear line-scanning unit within which the scanning unit 200 shown in FIG. 6 is mounted;

FIG. 8 is a schematic diagram depicting an example in which an additional light source unit 110a is added between beam spatial filter/expander 101 and beam splitter 104 shown in FIG. 2a and FIG. 2b; and

FIG. 9 is a schematic diagram of an entire confocal imaging apparatus by combining each unit shown in FIGS. 2a through 8.

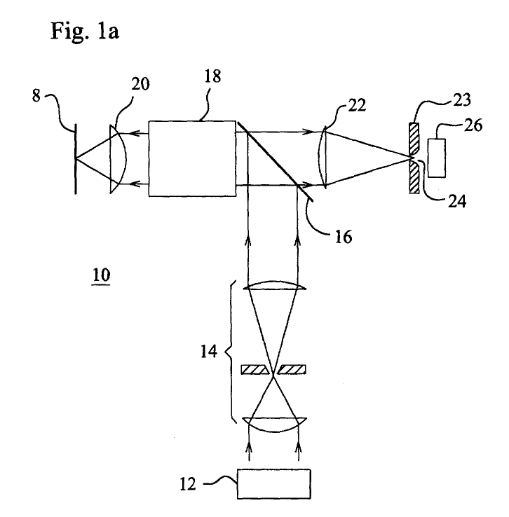

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

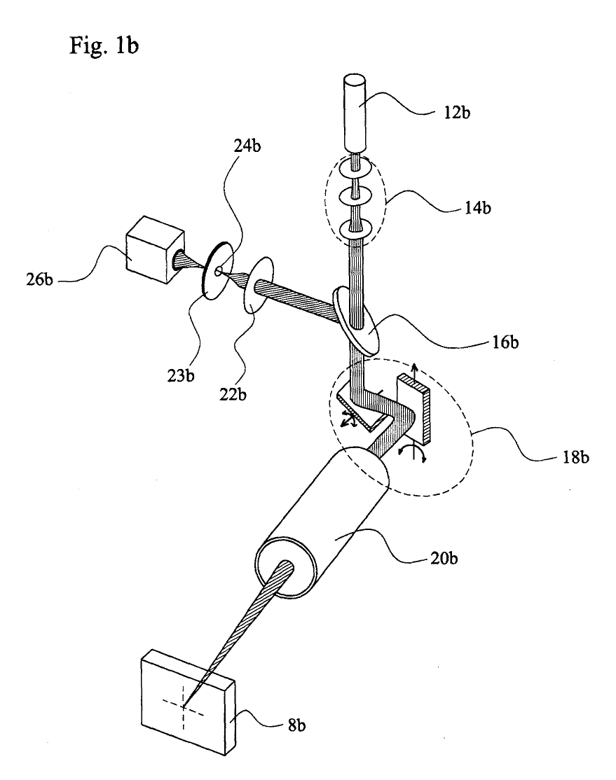

FIG. 2a is a schematic diagram of a confocal imaging apparatus in accordance with a preferred embodiment of the present invention, and FIG. 2b is a three-dimensional diagram of the confocal imaging apparatus of FIG. 2a. As depicted in FIG. 2a, the confocal imaging apparatus according to the present invention (please refer to the drawings 2 and 2b in FIG. 2a and FIG. 2b) includes a light source 100, a beam spatial filter/expander 101, a beam splitter 104, a scanning unit 200 which is mounted with a cylindrical objective lens 206, a cylindrical receiving lens 300, a slit mask 310, and an optical image processing unit 320.

The light source 100 emits a laser beam.

The beam spatial filter/expander 101 spatially filters the beam from the source 100, appropriately modifies the size and the shape of the cross section of the beam, and collimates the beam at least on the X-Z plane. The intersected plane of the beam with the entrance of the cylindrical objective lens 206 has rectangular shape and the beam intensity is uniform throughout the intersected plane. In this way, when the beam is focused to a slit-beam by the cylindrical objective lens 206, the intensity of the slit-beam becomes uniform along the slit-direction (hereinafter, slit-direction means the longitudinal direction of a slit).

The beam splitter 104 guides the beam from the beam spatial/expander 101 toward the scanning unit 200 and from the scanning unit 200 toward the cylindrical receiving lens 300.

The scanning unit 200 scans the beam from the beam splitter 104 across a specific plane 210 of a specimen 207 via the cylindrical objective lens 206. The procedure performed at the scanning unit 200 will be detailed later.

The cylindrical objective lens 206 is mounted on the moving stage of the scanning unit 200 in such a manner that its cylinder axis is parallel to the Y-axis, and its optical axis is parallel to the Z-axis. The cylindrical objective lens 206 focuses the incoming beam to a very narrow slit-beam on the focal plane 210 of the specimen 207. The slit-direction of the slit-beam is parallel to the Y-axis. The light illuminating the specimen 207 is scattered back and part of the scattered light is collected by the cylindrical objective lens 206. Among the collected light, only the light that is scattered back from the focal plane 210 is focused to a parallel propagating beam on the X-Z plane by the cylindrical objective lens 206. However, on the perpendicular plane to the X-Z plane, the light diverges, maintaining the same direction as that just after being scattered by the specimen since the cylindrical objective lens 206 does not have any lens effect in the direction of the Y-axis (hereinafter, such light is referred to as “collimated beam on the X-Z plane”, meaning that the light parallel propagates only on the X-Z plane). This collimated beam on the X-Z plane propagates towards the cylindrical receiving lens 300 via scanning unit 200 and beam splitter 104.

The cylindrical receiving lens 300 is disposed in such a manner that its cylinder axis is in parallel with the Y-axis, and its optical axis is in parallel with the X-axis. The lens 300 focuses the collimated beam on the X-Z plane to a very narrow slit-beam on the focal plane of the cylindrical lens 300.

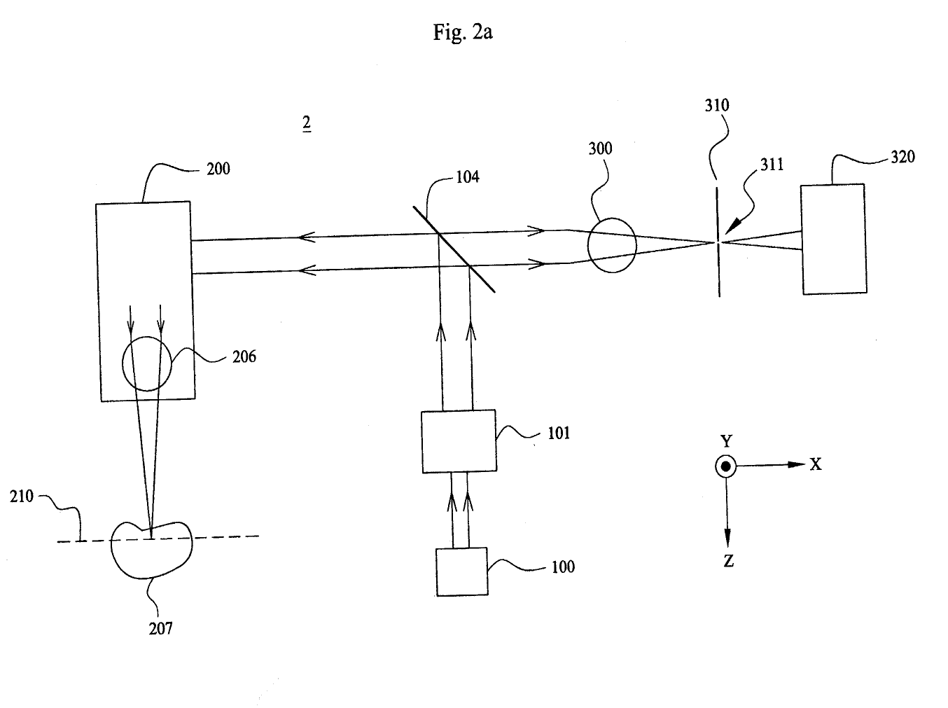

FIG. 3 illustrates an example of the slit mask 310 in accordance with the present invention. The slit mask 310 has a very narrow slit on the center of it. As depicted in FIG. 2a and FIG. 2b, the center of the slit 311 is positioned on the focal point of the lens 300, and the slit-direction of slit 311 is in parallel to the Y-axis. The slit-beam that is focused onto the slit 311 by the lens 300 can pass through the slit mask 310. In this way, among the light that is scattered back from many parts of the specimen 207, the mask 310 filters and delivers to the next unit only the light that is scattered back from the site of the slit-beam focused on the focal plane 210 of the specimen 207.

Referring again to FIG. 2a, the optical image-processing unit 320 extracts the necessary information from the light that passes through the slit 311, and forms an image of the specimen 207.

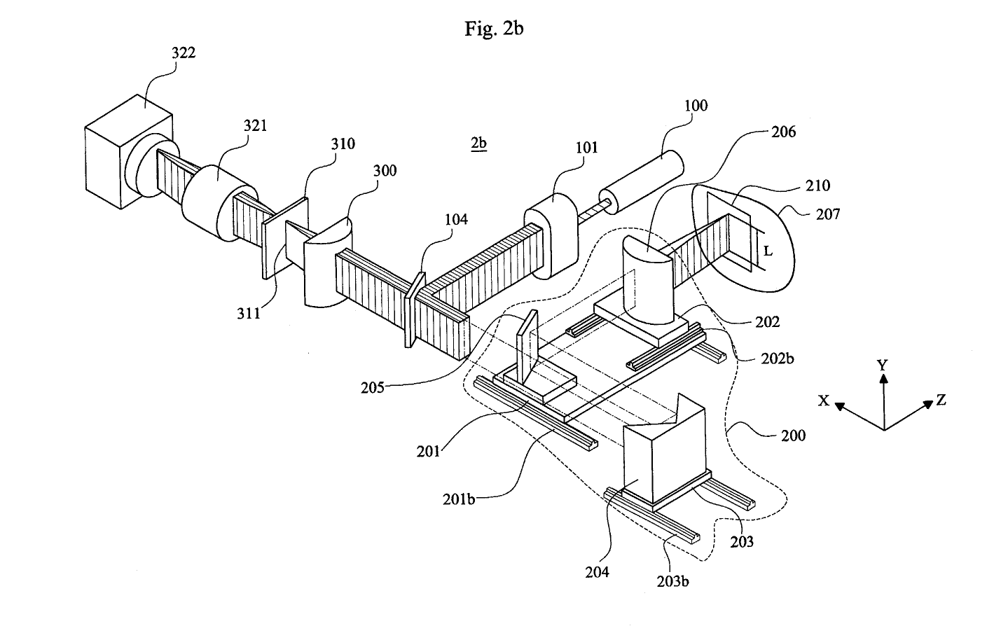

FIG. 4 depicts an example of the optical image processing unit 320 in accordance with the present invention. As shown in the drawing, the optical image processing unit 320 includes an optical image data acquisition unit 32 and an image constructing/analyzing unit 400.

The optical image data acquisition unit 32 includes an imaging optics 321, a line detector 322, a data acquisition unit 323, a controller 324, and a scanning/positioning driver 325. The optical image data acquisition unit 32 repeats the procedure of gathering the information of a line of pixels in parallel from the light that passes through the slit 311 in order to get raw data on the specimen 207. In detail, the imaging optics 321 focuses the light that passes through the slit 311 to a one-dimensional optical image on the sensing area of the line detector 322. The line detector 322 converts the one-dimensional optical image on the sensing area into a bunch of the corresponding electrical signal train. The data acquisition unit 323, complying with the control signal from the controller 324, receives and converts a bunch of the electrical signal train from the line detector 322 into digitized data of a line of pixels. The data of the lines of pixels are delivered to the image constructing/analyzing unit 400 as the raw data on the specimen.

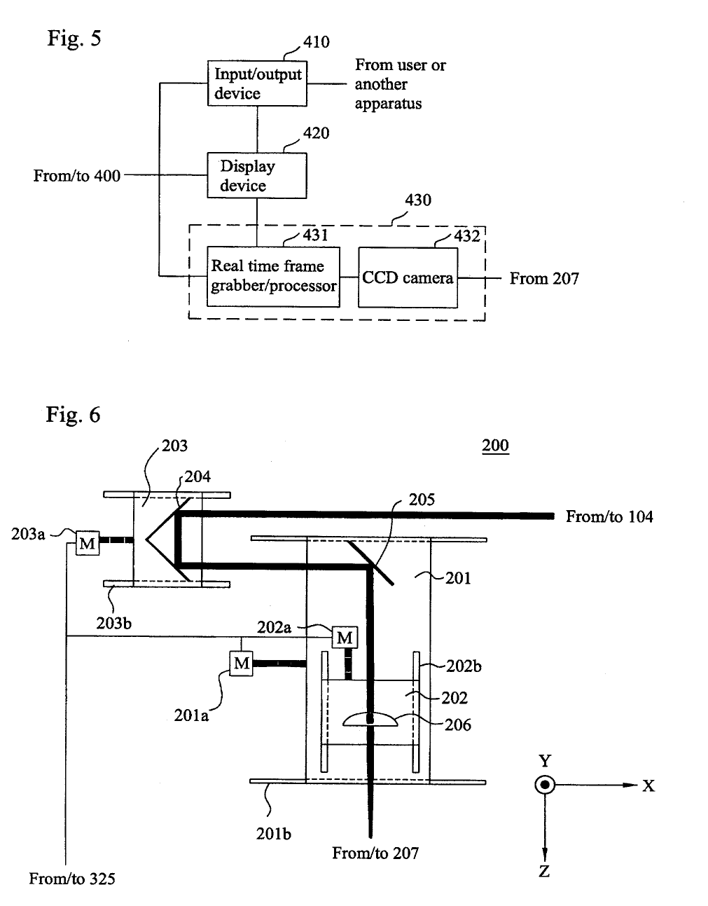

The scanning/positioning driver 325, complying with the control signal from the controller 324, drives the motors of the scanning unit 200 (it will be explained later) to scan and to position at every scanning stage (please refer to the reference numerals 201a, 202a, and 203a in FIG. 2b and FIG. 6). According to the command signal from the image constructing/analyzing unit 400, the controller 324 synchronizes the operations of the data acquisition unit 323 and the scanning/positioning driver 325 to get the information from a different site of the specimen.

The image constructing/analyzing unit 400 synthesizes and analyzes two-dimensional or three-dimensional structures of the specimen 207, by using raw data input from the data acquisition unit 323. In addition, the image constructing/analyzing unit 400 transmits the command signal to the controller 324 to operate the optical image data acquisition unit 32 in a desired manner.

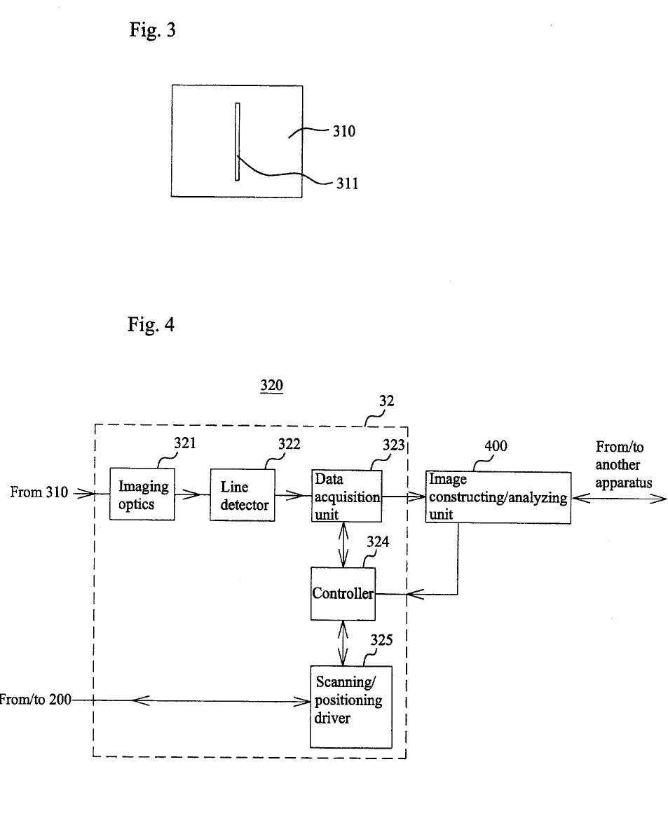

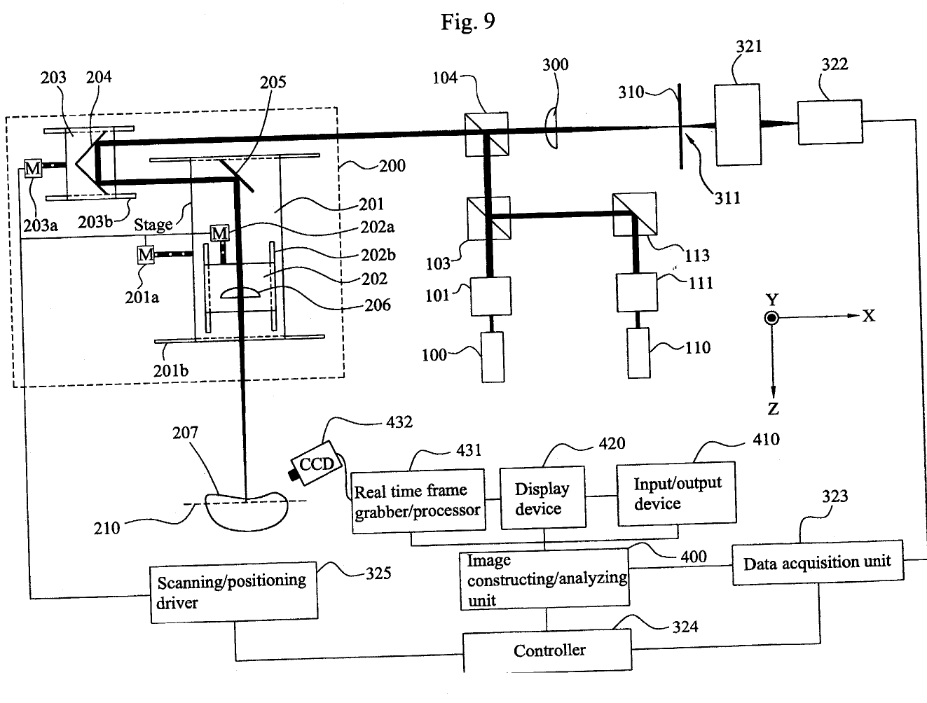

FIG. 5 illustrates an example of another apparatus, which can be connected to the image constructing/analyzing unit 400. The input/output device 410 interfaces a user or another apparatus to the image constructing/analyzing unit 400 or the display device 420. The display device 420 displays the signals from the image constructing/analyzing unit 400, the input/output device 410, and other apparatus connected to this apparatus (for example, an auxiliary imaging device 430 that will be explained below). The auxiliary imaging device 430 includes a real time frame grabber/processor 431 and a charge coupled device camera (CCD) 432, and provides the magnified image of the specimen 207 to the display device 420 in real time (please refer to FIG. 5 and FIG. 9). When the specimen is too small for a user to accurately align the beam to the target with naked eyes, the imaging device 430 can help the user by providing the appropriately magnified image of the specimen in real time. But the imaging device 430 does not optically disturb the main operation of forming the confocal image at all unlike in some cases where the magnified image is obtained by inserting some optical components into the main optical path through which the light propagates to form the confocal image. Moreover, the two-dimensional image of the specimen acquired by the imaging device 430 can be used by the constructing/analyzing unit 400 as auxiliary information to analyze the specimen.

Next, scanning unit 200 is explained in detail with reference to FIG. 6. FIG. 6 is a schematic diagram of the scanning unit 200 shown in FIG. 2a and FIG. 2b. As depicted in the drawing, the scanning unit 200 includes: the components 201, 201a, 201b, 202, 202a, and 202b that are related to linear line-scanning; the components 203, 203a, 203b, and 204 that are related to real-time optical path correcting; and the components 204 and 205 that are related to the optical path connecting.

First of all, the operation of the linear line-scanning is explained below. In order to get two-dimensional or three-dimensional images on the specimen 207, the slit-beam focused on the specimen 207 via the cylindrical objective lens 206 should be scanned across the specimen. For this purpose, in the present embodiment, two independent linear scanning motions of the slit-beam are performed in the direction of the X-axis and the Z-axis, respectively. An image frame can be acquired along any arbitrary desired plane that is parallel to the Y-axis, by combining two independent linear scanning motions of the slit-beam. In general, the image frame is obtained along the perpendicular plane to the optical axis (that is, the plane with the constant value of z). The three-dimensional range image of the specimen 207 is formed by stacking many image frames of different values of z in order. Hereinafter, linear scanning of the slit-beam is referred to as “linear line-scanning.”

The first scanning stage 201 moves linearly in the direction of the X-axis along the first rail 201b by the first motor 201a. The first plane mirror 205 and the second scanning stage 202 are mounted on the first scanning stage 201. The second scanning stage 202, on the other hand, moves linearly in the direction of the Z-axis along the second rail 202b by the second motor 202a, and the cylindrical objective lens 206 is mounted on the second scanning stage 202. The slit-beam focused on the specimen 207 by the cylindrical objective lens 206 is moved in the direction of the X-axis by the motion of the first scanning stage 201 and in the direction of the Z-axis by the motion of the second scanning stage. The scanning range and the scanning speed depend on the characteristics of the scanning stages and the driving motors. The scanning range of several tens of centimeters and the scanning speed of about 100 cm/sec can be easily reached.

The following is the explanation of the real-time optical path correction to compensate the change of optical path during linear line-scanning. Linear line-scanning to scan the slit-beam across specimen 207, which is carried out by moving the first scanning stage 201 and the second scanning stage 202, is accompanied by the change of optical path length between the cylindrical objective lens 206 and the imaging optics 321(please refer to FIG. 9). This change of the optical path length has undesired effects on the one-dimensional optical image on the sensing area of the line detector 322, which is formed by the imaging optics 321. The undesired effects include de-focusing, change of the image size, and change in the overall brightness. Removing these undesired effects on the image caused by the linear line-scanning is a very essential point for realizing the present apparatus. For this purpose, in the present embodiment, the real-time compensating of the change of optical path is carried out by the third scanning stage 203 and the retroreflector 204.

The third scanning stage 203 moves linearly in the direction of the X-axis along the third rail 203b by the third motor 203a. The retroreflector 204 is mounted on the third scanning stage 203. In order to compensate for the change of the optical path length in real time during linear line-scanning, the third scanning stage 203 moves synchronously to the moving of the first scanning stage 201 and the second scanning stage 202 in the following manner. If the first scanning stage 201 shifts by ΔX from a designated reference point Xₒ in the positive direction of the X-axis, the third scanning stage 203 shifts by 0.5ΔX from a designated reference point X_{co} in the positive direction of the X-axis. Similarly, if the second scanning stage 202 shifts by ΔZ from a designated reference point Zₒ in the positive direction of the Z-axis, the third scanning stage 203 shifts by 0.5ΔZ from a designated reference point X_{co} in the positive direction of the X-axis. Here, reference points, Xₒ, X_{co}, and Zₒ, are properly designated at the beginning.

As to optical path connecting during linear line-scanning, the first plane mirror 205 connects the optical path between a retroreflector 204 and the cylindrical objective lens 206 regardless of the motion of the first scanning stage 201 and the second scanning stage 202. The retroreflector 204 is disposed in such a way that the optical path is connected between the beam splitter 104 and the first plane mirror 205 via the retroreflector 204 regardless of the motion of the scanning stage 203. In result, the light propagates back and forth between the beam splitter 104 and the specimen 207 via the retroreflector 204, the first plane mirror 205, and the cylindrical objective lens 206 regardless of the instantaneous position of the stage 201, 202, and 203 during scanning.

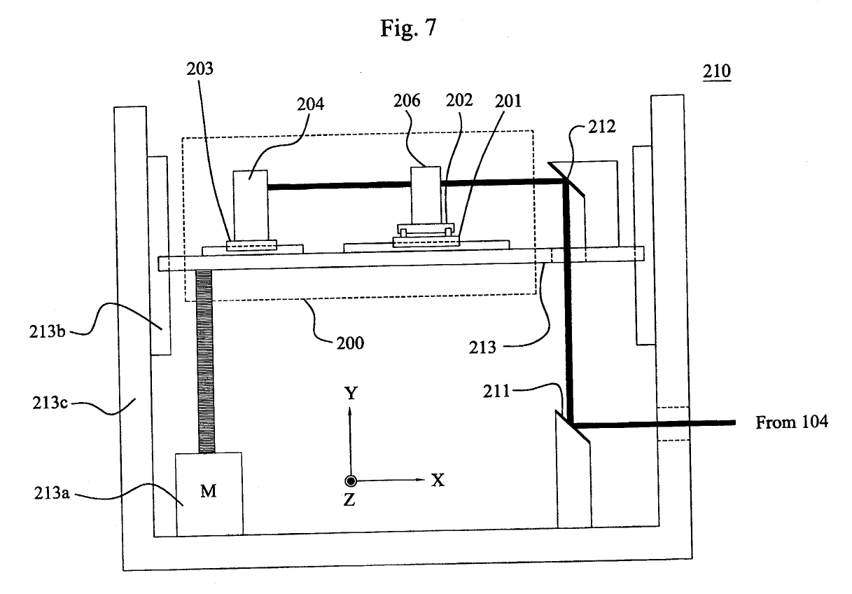

FIG. 7 is a schematic diagram of the stepped linear line-scanning unit 210 in accordance with another preferred embodiment of the present invention. It differs from the scanning unit 200 shown in FIG. 6 in that it has an additional stepping function in the direction of the Y-axis. When the scanning unit 200 is used, the length L of the slit-beam depicted in FIG. 2b limits the Y-directional field of view of an image frame. In order to extend the Y-directional field of view, the linear line scanning described above can be repeated for every stepping of the first slit-beam in the direction of the Y-axis by the length of L (hereinafter the scanning like this is referred to as “stepped linear line-scanning”). Besides the scanning unit 200 depicted in FIG. 6, the stepped linear line-scanning unit 210 shown in FIG. 7 includes a second plane mirror 211, a third plane mirror 212, a fourth scanning stage 213, a fourth motor 213a, a fourth rail 213b and a frame 213c. The scanning unit 200 is mounted on the fourth scanning stage 213. The fourth scanning stage 213 moves in the direction of the Y-axis along the fourth rail 213b by the fourth motor 213a. The fourth rail 213b is fixed on the frame 213c. The second plane mirror 211 is mounted on the frame 213c and the third plane mirror 212 on the fourth scanning stage 213 in the manner that the optical path is always connected between the beam splitter 104 and the retroreflector 204 regardless of the moving of the fourth scanning stage 213 along the fourth rail 213b.

The scanning units 200 and 210 depicted in FIGS. 6 and 7 include: the function of focusing the light to a slit-beam on the specimen 207; scanning the slit-beam across the specimen 207; compensating in real time the change of the optical path length caused by the scanning of the slit-beam; and connecting the optical path between the specimen 207 and the apparatus regardless of the scanning of the slit-beam. The scanning units 200 and 210 can be structurally separated from the other part of the present apparatus as far as the optical path is maintained without difficulty (please refer to the drawings 2 in FIGS. 2a and 2b in FIG. 2b). So, the convenience and the applicability of the apparatus to diverse specimens can be improved.

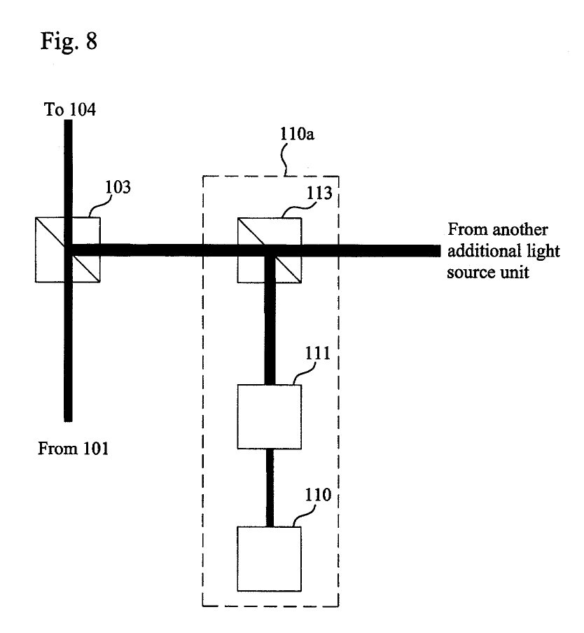

FIG. 8 illustrates an example of an additional light source unit 110a that is added between the beam spatial filter/expander 101 and the beam splitter 104 shown in FIG. 2a and FIG. 2b. This additional light source unit 110a includes a light source 110, a beam spatial filter/expander 111, and a beam splitter 113. The light from the additional light source unit 110a propagates to the beam splitter 104 via the beam splitter 103. The light source 110 emits the light of which wavelength is different from the light source 100 described above, providing a multi-spectral scanning function. Also, in the case that the main light source 100 emits invisible light, the additional light source 110 can provide the visible light as an indicator necessary for alignment of the scanning unit 200 or 210 to the target. More than one additional light source unit can be attached in parallel by a similar manner as described above.

FIG. 9 is a schematic diagram of the entire confocal imaging apparatus including every component depicted in FIGS. 2a through 8. With reference to FIG. 9, the main procedure of forming the confocal image is briefly summarized below.

At first, the illuminating beam from the light source 100 passes through the beam spatial filter/expander 101 to become a collimated beam at least on the X-Z plane with the appropriate cross section. Then, the collimated beam is guided to the scanning unit 200 through the beam splitter 104. The beam that is guided to the scanning unit 200 is focused to a very narrow first slit-beam on the specimen 207 by the cylindrical objective lens 206. The first slit-beam is scanned linearly and independently both in the direction of the X-axis by the first scanning stage 201 and in the direction of the Z-axis by the second scanning stage 202, which consequently yields image frames along arbitrary desired planes that are parallel to the Y-axis. During the scanning of the first slit-beam, the change of optical path length between the cylindrical objective lens 206 and the imaging optics 321 can be compensated in real time by moving the retroreflector 204 synchronously to the motions of the first plane mirror 205 and the objective lens 206. The light illuminating specimen 207 is scattered back and part of the scattered light is collected by the objective lens 206. Among the collected light, only the light scattered back from the focal plane 210 is focused to a collimated beam on the X-Z plane by the cylindrical objective lens 206. This collimated beam on the X-Z plane propagates to the cylindrical receiving lens 300 via the beam splitter 104 and focused to the second slit-beam on the focal plane of the receiving lens 300, and passes through the slit 311 of the slit mask 310. The light that passes through the slit 311 is focused to a one-dimensional optical image on the sensing area of the line detector 322 by the imaging optics 321. In order to get confocal images of the specimen 207, the line detector 322 and the data acquisition unit 323 operate synchronously to the scanning operation of the first slit-beam, extracting the necessary information from the one-dimensional optical image in parallel mode, i.e., the mode acquiring the whole information over a line of pixels at a time. This raw data from the data acquisition unit 323 is delivered to the image constructing/analyzing unit 400, synthesized into the confocal images of the specimen, and analyzed. The additional light source 110 provides the multi-spectral scanning function. Further, the two-dimensional magnified image of the specimen 207 can be provided to the display device 420 and the image constructing/analyzing unit 400 in real time by the auxiliary imaging unit 430 for user's convenience and another application.

According to the present invention, the scanning unit can linearly scan the slit-beam along the arbitrary desired planes that are parallel to the Y-axis to get the image frames of the specimen. Moreover, the scanning unit has the function of compensating the change of the optical path length in real time, while scanning the slit-beam across the specimen. In result, the in-focused clear image is always formed on the sensing area of the line detector with constant magnification during the scanning. Further, the scanning unit can be structurally separated from the other part of the present apparatus as far as the optical path is maintained without difficulty. So, the convenience and the applicability of the apparatus to diverse specimens can be improved.

As to the resolution of the present apparatus, the spatial resolution in the direction of the X-axis is dominated by the largest one among the resolution limited by sampling interval in the direction of the X-axis, the positional resolution of the scanning stage, and the optical resolution limited by diffraction; the spatial resolution in the direction of the Z-axis is dominated by the largest one among the resolution limited by sampling interval in the direction of the Z-axis, the positional resolution of the scanning stage, and the optical resolution limited by the slit confocal optic configuration. In the macroscopic application, the resolution limited by sampling interval is usually much larger than the others. For example, if the data is sampled 1,024 times over 10 cm, the spatial resolution limited by sampling interval becomes about 200 μm. On the other hand, the spatial resolution in the direction of the Y-axis is dominated by the larger one of two values: one of which is the resolution determined by the quantity that is the length of the slit-beam L divided by the number of pixels N of the line detector; and the other of which is the optical resolution of the imaging optics in the direction of the Y-axis. In macroscopic application, the former is usually larger. For example, if L is 10 cm and N is 1,024 then, the spatial resolution in the direction of the Y-axis is about 200 μm. That is to say, as far as the macroscopic application is concerned, the spatial resolution is usually limited by the spatial sampling rate.

As to the image acquisition speed of the present apparatus, the beam-scanning time across the specimen to get the image frame, which is a bottleneck to enhance the image frame rate, can be considerably shortened by using linear line-scanning of the present invention, compared with the prior art raster-scanning apparatus. For example, let the length of the slit-beam be 10 cm and the speed of the linear scanning stage in the direction of the X-axis be 100 cm/sec. The apparatus of the present invention takes 100 msec to obtain a frame of the specimen of 10 cm×10 cm. This is much shorter than 5 ˜80 sec, the time taken to obtain a frame of the specimen of 7.5 cm×7.5 cm by the confocal macroscope which is developed by the Scanning Laser Microscopy Laboratory at the University of Waterloo in Ontario, Canada.

Lastly, as to the field of view of the present apparatus, the field of view of ˜10 cm×˜10 cm or more can be realized without any critical difficulty by using the scanning units of the present invention.

In conclusion, the present invention is very advantageous for obtaining the confocal images of macroscopic specimens that have a large area with large frame rate. It can be used for various applications in medicine, biology, material science, and industry; for example, it can be applied as a biochip reader, an in-vivo macroscope to observe tissue, a surface profiler with a large field of view, and as a three-dimensional digitizer.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A confocal imaging apparatus for acquiring confocal images of a macroscopic specimen, said apparatus comprising:
an illuminating means for providing an illuminating beam;
a first focusing means for focusing said illuminating beam to a first slit-beam on said specimen;
a light-collecting means for collecting the light scattered from said specimen;
a second focusing means for focusing the light collected by said light-collecting means to a second slit-beam;
a scanning means for scanning said first slit-beam across arbitrary desired planes that are parallel to the slit-direction of said first slit-beam;
an optical path-connecting means interlocked with said scanning means, for connecting the optical path between said specimen and said apparatus during scanning of said first slit-beam by said scanning means;
a real-time optical path-correcting means interlocked with said scanning means, for compensating the change of optical path length in real time during the scanning of said first slit-beam by said scanning means;
a filtering means for filtering only said second slit-beam; and
an optical image processing means for forming images of said specimen by extracting the necessary information from the filtered second slit-beam passing through said filtering means.

2. The apparatus as claimed in claim 1, wherein both said first focusing means and said light-collecting means are simultaneously embodied by a first cylindrical lens.

3. The apparatus as claimed in claim 1, wherein said illuminating means further comprises:
a means for transforming said illuminating beam into a beam propagates parallel at least in the plane perpendicular to the slit-direction of said first slit-beam; and
a means for equalizing the intensity of said first slit-beam along slit-direction by making the intersected plane of said illuminating beam with the entrance of said first focusing means having a rectangular shape, and by making the intensity uniform throughout the rectangular intersected plane.

4. The apparatus as claimed in claim 1, wherein said second focusing means is embodied by a second cylindrical lens.

5. The apparatus as claimed in claim 1, wherein said filtering means is disposed on a focal plane of said second focusing means, and comprises a slit mask on which a slit is formed for filtering said second slit-beam.

6. The apparatus as claimed in claim 1, wherein said scanning means, said first focusing means, said optical path-connecting means, and the real-time optical path-correcting means are combined into one structural unit that is referred to as a scanning unit; and
said scanning means further comprises a linear line-scanning means carries out two independent linear scanning motions of said first slit-beam to acquire two-dimensional or three-dimensional range images of said specimen, one of which is a scanning motion in a perpendicular direction to both the optical axis of said first focusing means and the slit-direction of said first slit-beam, and the other of which is a scanning motion in a parallel direction to the optical axis of said first focusing means.

7. The apparatus as claimed in claim 6, wherein said linear line-scanning means comprises:
a first scanning stage for moving linearly in a perpendicular direction to both the optical axis of said first focusing means and the slit-direction of said first-slit beam; and
a second scanning stage, on which said first focusing means is mounted, mounted on said first scanning stage, for moving linearly in a parallel direction to the optical axis of said first focusing means.

8. The apparatus as claimed in claim 6, wherein said optical path-connecting means comprises a retroreflector and a first plane mirror disposed in the way that optical path are always connected between said specimen and said apparatus during the scanning of said first slit-beam by said linear line-scanning means.

9. The apparatus as claimed in claim 6, wherein said real-time optical path-correcting means comprises a third scanning stage on which said retroreflector of said optical path-connecting means is mounted; and
said third scanning stage moves synchronously to the motions of said first scanning stage and said second scanning stage in a way that the change of the optical path length, which is caused by the scanning of said first slit-beam by said linear line-scanning means, is compensated.

10. The apparatus as claimed in claim 1, wherein said optical image processing means further comprises:
an imaging optics for focusing said filtered second slit-beam into a one-dimensional optical image on a sensing area of a line detector;
a data acquisition means for extracting the information on said specimen over said first slit-beam in parallel from said one-dimensional optical image; and
an image constructing/analyzing means for constructing two-dimensional or three-dimensional range images of said specimen by using said information that is delivered from said data acquisition means.

11. The apparatus as claimed in claim 10, further comprising an auxiliary real-time imaging means disposed out of the optical path that is related for confocal imaging, for providing a magnified image of said specimen in real time without disturbing the confocal imaging.

12. The apparatus as claimed in claim 6, further comprising a stepped linear line-scanning means for repeating said linear line-scanning operation, while stepping said first slit-beam by the length of said first slit-beam in the slit-direction of said first slit-beam.

13. The apparatus as claimed in claim 12, wherein said stepped linear line-scanning means comprises:
a fourth scanning stage on which said line-scanning means is mounted, for moving in the slit-direction of said first slit-beam; and
an additional optical path-connecting means comprises a second plane mirror and a third plane mirror, for connecting the optical path between said specimen and said apparatus regardless of the stepping motion of said fourth scanning stage.

14. The apparatus as claimed in claim 1, further comprising at least one additional illuminating means provides said scanning means with an illuminating beam different from said illuminating beam.

15. A method for acquiring the confocal images of a specimen; said method comprising the steps of:
providing the illuminating beam;
focusing said illuminating beam to said first slit-beam on said specimen;
collecting the light scattered from said specimen;
focusing said collected light to said second-slit beam;
scanning the first slit-beam across arbitrary desired planes that are parallel to the slit-direction of said first slit-beam;
connecting the optical path between said specimen and said apparatus during the scanning of said first slit-beam;
compensating the change of optical path length in real time during the scanning of said first slit-beam;
filtering only said second slit-beam and passing the filtered second slit-beam to the optical image processing means; and
forming images of said specimen by extracting the necessary information from said filtered second slit-beam.
